(19) United States
(12) Patent Application Publication
(10) Pub. No.: US 2008/0116320 A1
(43) Pub. Date: May 22, 2008

(54) Aircraft With Wings Whose Maximum Lift Can Be Altered By Controllable Wing Components

(75) Inventors: Alexender Van Der Velden, Atlanta, GA (US); Roland Kelm, Hamburg (DE); Josef Mertens, Bremen (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Airbus Deutschland GmbH, Hamburg (DE)

(21) Appl. No.: 11/663,055

(22) PCT Filed: Sep. 21, 2005
(86) PCT No.: PCT/EP05/10228

§ 371 Date: Mar. 16, 2007

Related U.S. Application Data
(60) Provisional application No. 60/631,302, filed on Nov. 29, 2004.

(30) Foreign Application Priority Data
Sep. 21, 2004 (DE) 10 2004 045 732.8

(51) Int. Cl. B64C 13/16; G05D 1/08

(52) U.S. Cl. 244/175

(57) ABSTRACT

The present invention relates to an aircraft with wings whose maximum lift can be altered by controllable wing components. By means of a regulating device (20), depending on flight state parameters and the actually measured load on the wings (10), wing components (11, 12) are acted upon such that the maximum possible aerodynamic lift does not exceed a desired upper limit value.

This application claims the benefit of the filing date of U.S. Provisional Patent Application No. 60/631,302 filed Nov. 29, 2004 and of German Patent Application No. 10 2004 045 732.8 filed Sep. 21, 2004, the disclosure of both applications is hereby incorporated herein by reference.

### FIELD OF THE INVENTION

The present invention relates to an aircraft with wings whose maximum lift can be altered by controllable wing components. It is the purpose of the invention to reduce the structural weight of an aircraft, which reduction can be achieved in that the maximum possible load acting on the wings is limited by means of a suitable control system.

### BACKGROUND OF THE INVENTION

In the case of high wing loads in an aircraft it is known to achieve a reduction in the bending moment of the wings in that the outboard ailerons are adjusted so as to achieve a reduction in lift while at the same time, by way of compensation for this reduction in lift, the angle of attack of the inboard wing is increased. This known counterchange of the wing configuration requires considerable regulating effort, and in practical application has only resulted in comparatively modest savings in structural weight.

### SUMMARY OF THE INVENTION

It is an object of the present invention to design an aircraft according to the precharacterising part of claim 1 such that a noticeable reduction in the structural weight of the wings can be achieved, wherein in particular in regard to gust loads the international certification regulations concerning load factors are to be taken into account.

According to the invention the object of the invention is met in that in an aircraft according to the precharacteristing part of claim 1 detectors are provided which during flight register the actual wing load at any given time, and in that a control device or regulating device is provided which then acts on the wing components, in the sense of reducing the maximum possible lift, when a predefined value of the wing load is reached.

Consequently, the design according to the invention leads to a reduction of the maximum possible wing load by forces resulting from aerodynamic lift at the expense of additional resistance. However, since this effect only takes place in those operating states in which only limited lift of the wings is required, the possible maximum load of the wing structure can be reduced in this way, and thus the structural weight can be correspondingly reduced without disregarding the safety aspects prescribed by international certification regulations.

According to the invention the wing components are then adjusted in the sense of a reduction in lift when the aircraft is above its operating point A₂ (in other words the approach speed with flaps retracted) in the range of the average flight speed. Generally speaking, the effect on the wing components is opposite the normal effects, known in the state of the art, for increasing wing lift. In this process the resistance increases at the same time to the extent to which the maximum load which a wing can generate is reduced. During high flying speeds the wing components can be returned to the normal position because in these flight states the lift and thus the maximum load on the wings is anyway limited by the compressibility of the air.

According to a further embodiment of the invention, parameters such as for example speed, altitude, air path climb angle, angle of attack, etc. which are subsumed as flight state parameters in the scope of the present invention, are additionally fed to the control device or regulating device as control variables or regulating variables; and control rules or regulating rules are installed which prevent the wing components from being adjusted, in the sense of a reduction in lift, before an unstable flight state is reached. This design according to the invention makes it possible to extend as far as possible the operating range within which a reduction in the maximum possible lift of the wings is adjustable, i.e. to fully utilise the lower limit value of lift generation, which limit value has to be maintained in order to ensure safe flight and safe manoeuvrability of the aircraft.

According to another aspect of the invention, for the purpose of registering the wing load, the deflection of the wings is to be measured by means of sensors arranged at suitable positions in the wings. Such sensors can for example be wire strain gauges.

According to still another aspect of the invention, trailing-edge flaps, known per se, on the wings serving as lift-altering wing components. However, extendable stallstrips in the leading-edge region of the wings are also possible, either as an alternative or in addition.

Moreover, according to a further aspect of the invention the stallstrips are completely retractable into the contour of the wings, and the movement wells are closable by means of suitable covers. In this way it is possible to avoid additional resistance and thus loss in those operating regions where a reduction in lift is not desired.

In any case it might be advantageous if the lift-reducing components are arranged in those regions of the wings that are located away from the fuselage, because a reduction in the maximum possible forces resulting from aerodynamic lift in the outboard regions of the wings has a greater effect on bending loads than does a reduction in the inboard regions of the wings.

### BRIEF DESCRIPTION OF THE DRAWINGS

Below, the invention is explained with reference to the enclosed drawings, as follows:

FIG. 1 a diagrammatic view of an aircraft with wing components that are controllable according to the invention, including a diagrammatic view of a control device and regulating device; and

FIG. 2 a diagram in which the load of the wing of an aircraft is shown depending on the angle of attack, and above it the diagrammatic view of a cross section of an associated wing.

### DETAILED DESCRIPTION OF AN EXEMPLARY EMBODIMENT

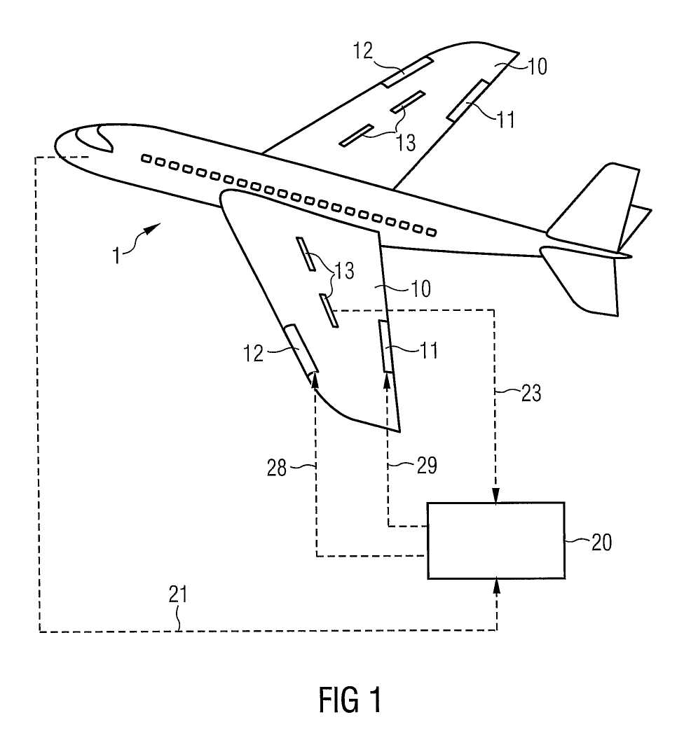

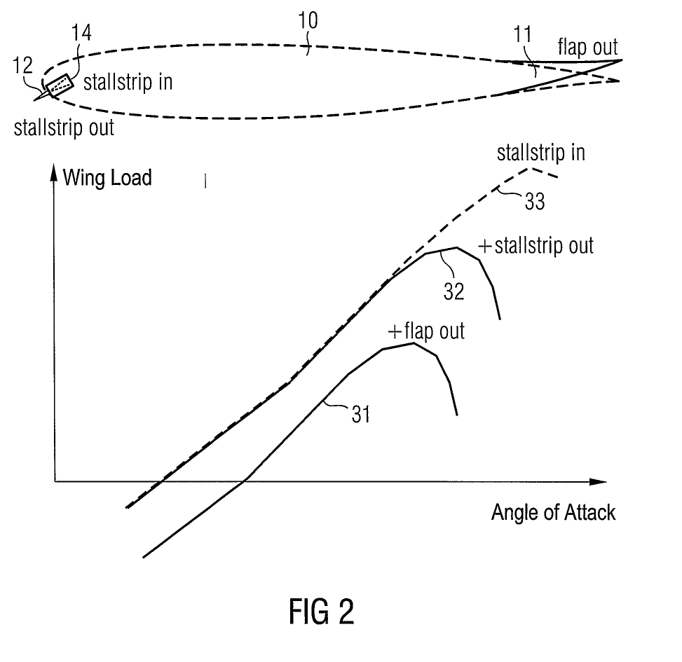

The aircraft shown in FIG. 1, overall designated 1, comprises wings 10 which in their regions away from the fuselage comprise trailing-edge flaps 11 and, alternatively or in addition, in their leading-edge regions comprise stallstrips 12. The stallstrips 12 are of the type extendable from a well 14 (compare FIG. 2), thus forming a spoiling edge for the airflow. In FIG. 1 the depiction of the device according to the invention merely relates to one wing of the aircraft, but it is to be provided in the same way for both wings. Activation of the trailing-edge flap 11 takes place by way of a control line 29, while activation of the stallstrip 12 takes place by way of an effective connection 28. The control line 29 and the effective connection 28 lead from a central control device or regulating device 20 to the wing components. By way of a first input line 23 a signal reflecting the actual load on the wing 10 is transmitted to the control device or regulating device 20. The wing load is determined by way of sensors 13 arranged at suitable positions in the wing 10. In addition, by way of a second input line 21, flight state parameters such as e.g. speed, altitude, air path climb angle, angle of attack etc. are transmitted to the control device or regulating device 20. The control rules or regulating rules of the control device or regulating device 20 are tailored to the respective aircraft type so that the geometry modification caused by the effective connection 28 and the control line 29 reduces the maximum possible load factor in the precisely desired way.

The curves 31, 32, 33 in the diagram according to FIG. 2 show the dependence of the maximum possible wing load on the angle of attack. By way of an adjustment component in the sense of the invention, the wing 10, schematically shown above the diagram, comprises a hingeable trailing-edge flap 11 and a stallstrip 12 that is retractable into a well in the leading-edge region of the wing. If the stallstrip 12 is extended from the well 14 then a spoiling edge arises, which significantly reduces the lift of the wing 10. The first curve 31 in FIG. 2 shows the reduction in wing load as the angle of attack increases from the point “flap out”, designated by a cross, i.e. from an operating point at which the trailing-edge flap 11 was hinged upward, i.e. into a position in which a reduction in lift occurs, by the control device 20 by way of the control line 29.

Analogously, the second curve 32 shows the decrease in wing load when the stallstrip 12 is extended (in FIG. 2 marked with the cross “stallstrip out”).

The dotted curve 33 in FIG. 2 shows the dependence of the wing load on the angle of attack without any lift-reducing effect on the trailing-edge flap or the stallstrip; it shows that in the upper region the maximum load is limited due to the compressibility of the air. In this region the stallstrip 12 would be retracted in the well 14 (stallstrip in) during flight operations.

Calculations relating to the wing of a large passenger aircraft have shown that if the trailing-edge flap is swivelled upward by approximately 10°, a reduction in the maximum lift of approximately 13% is achieved. The resulting additional resistance of the aircraft was approximately 5%. It can be assumed that trailing-edge adjustment in the sense of reducing maximum lift is required only during 5% of the flight time to be considered, so that the additionally generated resistance would only translate into a reduction of 0.25% in the flying range of the aircraft. On the other hand, calculations show that the 13% load reduction would return a reduction in the weight of the wing, which reduction because of the correspondingly increased fuel tank capacity would translate into a gain of 2% in the flying range. A comparison shows that a large passenger aircraft designed according to the invention could achieve a net gain of approximately 1.7% in its flying range.

### LIST OF REFERENCE SIGNS

1 Aircraft
10 Wing
11 Trailing-edge flap
12 Stallstrip
13 Sensors
14 Well
20 Central control device or regulating device
21 Second input line
23 First input line
28 Effective connection
29 Control line
31 First curve
32 Second curve
33 Dotted curve

1. An aircraft having wings, comprising:
at least one controllable wing component;
at least one detector; and
a control device coupled to the at least one detector and the at least one controllable wing component;
wherein said at least one controllable wing component is arranged to alter the maximum lift of the wings in the sense of a reduction in lift, when the aircraft is in an operating state of a predetermined flight speed,
wherein said at least one detector is adapted to register the actual wing load at any given time during flight, and
wherein said control device acts on the at least wing components, in the sense of reducing the maximum possible lift, when the actual wing load reaches a predefined value of the wing load.

2. The aircraft according to claim 1,
wherein said at least one controllable wing component is then adjusted in the sense of a reduction in lift, when the aircraft is above its operating point A₂ in the range of average flight speeds.

3. The aircraft according to claim 1,
wherein said control device is additionally provided with flight state parameters as control variables.

4. The aircraft according to claim 3,
wherein said control device is featured with control rules analyzing the flight state parameters to prevent said at least wing component from being adjusted, in the sense of a reduction in lift, before an unstable flight state is reached.

5. The aircraft according to claim 1, further comprising
at least one sensors arranged at a suitable position on each wing, which measures the deflection of the wing for the purpose of registering the load on the wings.

6. The aircraft according to claim 1, further comprising:
at least one trailing-edge flap on each of the wings, serving as a lift-altering wing component.

7. The aircraft according to claim 1, further comprising:
at least one extendable stallstrip in the leading-edge region of each wing serving as a lift-reducing wing component.

8. The aircraft according to claim 7, wherein said at least one stallstrip is arranged to be completely retractable into a well formed in the contour of the wing.

9. The aircraft according to claim 8, wherein the well is closable by cover.

10. The aircraft according to claim 7,
wherein said at least one lift-reducing controllable wing component is arranged in a region of a wing that is located away from the fuselage of the aircraft.
